(19) United States
(12) Patent Application Publication
(10) Pub. No.: US 2008/0155639 A1
(43) Pub. Date: Jun. 26, 2008

(54) DATA RECEIVING APPARATUS

(75) Inventor: Tatsuya MIYAGI, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/773,070

(22) Filed: Jul. 3, 2007

(30) Foreign Application Priority Data
Dec. 26, 2006 (JP) 2006-349286

(51) Int. Cl. H04N 7/16; H04N 7/01

(52) U.S. Cl. 725/139; 348/441; 348/E07.003

(57) ABSTRACT

A video signal receiving apparatus controls a video display portion to display an error message when a video signal is received in a nonconforming video format. A user checks an error message and selects Yes through an input portion. A control portion of a video signal receiving apparatus controls a hot plug detection signal transmitting portion to transmit a Low signal serving as a reset signal as a hot plug detection signal for a predetermined period of time. At this time, a control portion of a video signal transmitting apparatus receives the Low signal for the predetermined period of time to reset a video format or the like, requires EDID to transmit a video signal in an optimum video format, and retransmits the video signal in the optimum video format to the video signal receiving apparatus in accordance with the EDID.

The present application is based on Japanese patent application No. 2006-349286, the entire contents of which are incorporated herein by reference.

### BACKGROUND OF THE INVENTION

1. Field of the Invention

One embodiment of the present invention relates to a data receiving apparatus and, more particularly, to a data receiving apparatus which receives data in conformity to the HDMI standard.

2. Description of the Related Art

As a conventional technique, a video signal output apparatus being in conformity to a plurality of video formats are known. This technique is described in, for example, the Japanese Patent Kokai No. 2005-167895.

The video signal output apparatus is connected to a video display apparatus which displays a video image in accordance with a video signal. This video display apparatus outputs video format information such as 480 progressive or 1080 interlace to the video signal output apparatus.

The video signal output apparatus compares variable video format information with the input video format information to select a video format common in both the apparatuses and to output the selected video format information to the video display apparatus.

When the video display apparatus displays the selected video format information on its display screen, a user determines a display format desired for display in accordance with the displayed video format information.

When video format information determined by a user is output to the video signal output apparatus, the video signal output apparatus outputs a video signal in the determined video format to the video display apparatus.

In this manner, the user can appreciate a video in her/his desired video format.

However, according to a conventional video signal output apparatus, when a video signal is transmitted in a video format in which the data cannot be displayed by a video display apparatus, the video display apparatus displays, for example, only an error indication and cannot instruct the video signal output apparatus to retransmit a video signal of a suitable video format.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram showing a video display system according to an embodiment of the present invention;

FIG. 2 is an exemplary block diagram showing the video display system according to the embodiment of the present invention;

FIG. 3 is an exemplary schematic diagram showing an error message displayed on a video display portion according to the embodiment of the present invention; and

FIG. 4 is an exemplary timing chart according to the embodiment of the present invention.

### DETAILED DESCRIPTION OF THE PREFERRED EMBODIMENTS

Various embodiments according to the invention will be described hereinafter with reference to the accompanying drawings. In general, according to one embodiment of the invention, there is provided a data receiving apparatus, including: a transmitting/receiving portion which transmits or receives data; an output portion which performs data outputting of an audio signal or an image signal in accordance with reception of the data; and a control portion which, when the received data has a format different from a format in which the data can be output from the output portion, controls the transmitting/receiving portion to transmit a reset signal.

According to the configuration as described above, there can be provided a data receiving apparatus which instructs an external apparatus connected thereto to retransmit data of a format conforming to display when nonconforming data is received.

According to the present invention, when nonconforming data is received, data of a format conforming to display can be retransmitted.

### Embodiment

### (Configuration of Video Display System)

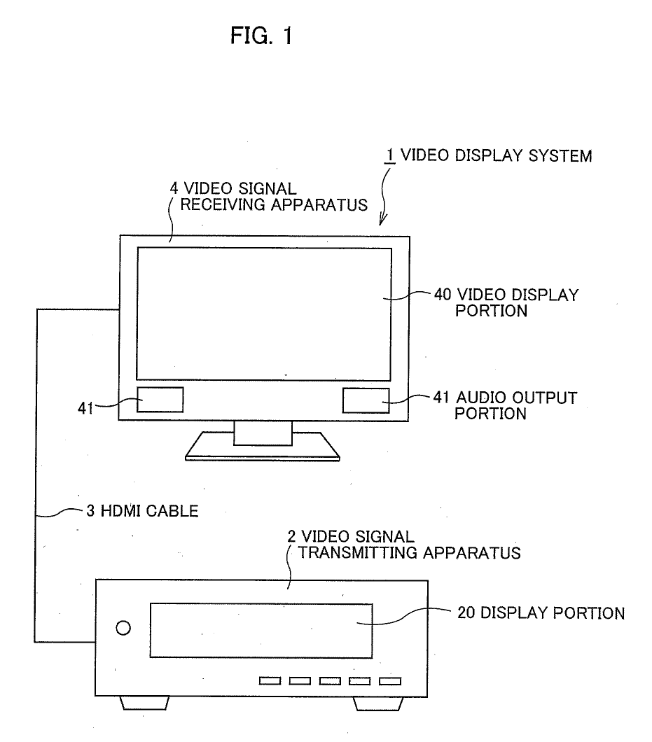

FIG. 1 is an exemplary schematic diagram showing a video display system according to an embodiment of the present invention.

A video display system 1 has a video signal transmitting apparatus 2 having a display portion 20 which displays reproducing time or the like and an HDMI port conforming to the HDMI standard; an HDMI cable 3 in which a video signal or the like propagates and which conforms to the HDMI standard; and a video signal receiving apparatus 4 serving as a data receiving apparatus which has a video display portion 40 on which a video is displayed, a audio output portion 41 which outputs audio, and an HDMI port conforming to the HDMI standard.

For example, as the video signal transmitting apparatus 2, a streaming video transmitting apparatus, a DVD (Digital Versatile Disk) player, a tuner, a set top box, or the like is used. However, another apparatus may be used.

For example, as the video signal receiving apparatus 4, a television receiver, a monitor apparatus for a PC (Personal Computer), or the like is used. However, another apparatus may be used.

The HDMI standard is a standard obtained by adding a audio transmitting function, a copyright protecting function, and a color difference transmitting function to a DVI (Digital Visual Interface) which is a standard of measure for connection between a PC and an image display apparatus.

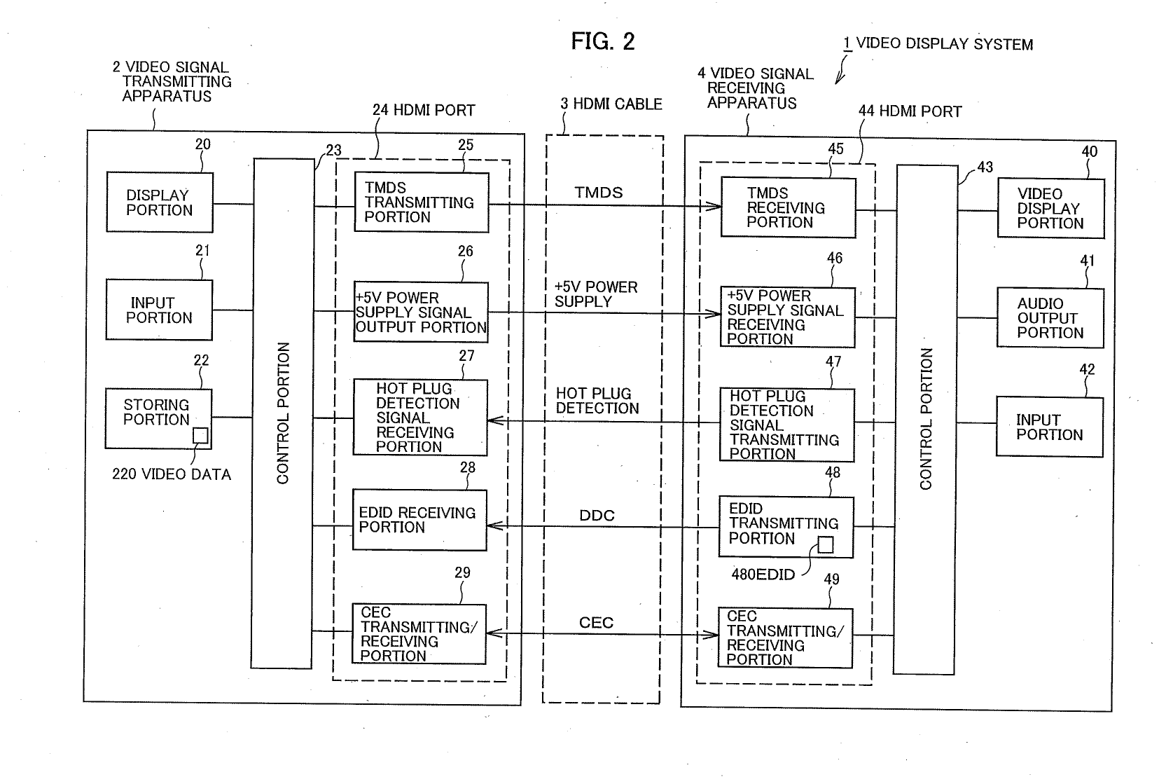

FIG. 2 is an exemplary block diagram showing the video display system according to the embodiment of the present invention.

The video signal transmitting apparatus 2 has the display portion 20, an input portion 21 which can be operated for some kind of operation, a storing portion 22 which stores video data 220 or the like, a control portion 23 which generally controls the respective portions, and an HDMI port 24 connected to the HDMI cable 3.

A main pin arrangement of the HDMI port 24 is constituted by TMDS (Transmission Minimized Differential Signaling), a +5V power supply, hot plug detection, DDC (Display Data channel) and CEC (Consumer Electronics Control).

The HDMI port 24 has a TMDS transmitting portion 25 which transmits a video signal or the like, a +5V power supply signal output portion 26 which outputs a +5V power supply signal serving as a signal which informs a destination apparatus of connection, a hot plug detection signal receiving portion 27 which receives a hot plug detection signal, an EDID receiving portion 28 which receives production information of the connected destination apparatus or an EDID 480 serving as data such as a conforming video format, and a CEC transmitting/receiving portion 29 which transmits/receives an apparatus control signal and a CEC serving as a control protocol.

As the hot plug detection signal, a High signal is transmitted to start an authentication operation for the destination apparatus when communication between apparatuses conforming to the HDMI standard is established, and a Low signal is transmitted when the communication is not established.

The HDMI cable 3 is connected to the HDMI ports 24 and 44 and is of a 19-pin type or a 29-pin type. In this embodiment, it is assumed that the HDMI cable 3 having 19 pins is used.

The video signal receiving apparatus 4 has the video display portion 40, the audio output portion 41 which reproduces and output audio, an input portion 42 which can be variably operated, a control portion 43 which controls respective portions, and the HDMI port 44 connected to the HDMI cable 3.

The HDMI port 44 has a TMDS receiving portion 45 which receives TMDS, a +5V power supply signal receiving portion 46 which receives a +5V power supply signal, a hot plug detection signal transmitting portion 47 serving as a reset signal transmitting portion which transmits a hot plug detection signal, an EDID transmitting portion 48 which has an EDID 480 and transmits the EDID 480, and a CEC transmitting/receiving portion 49 which transmits or receives CEC.

### Operation of Embodiment

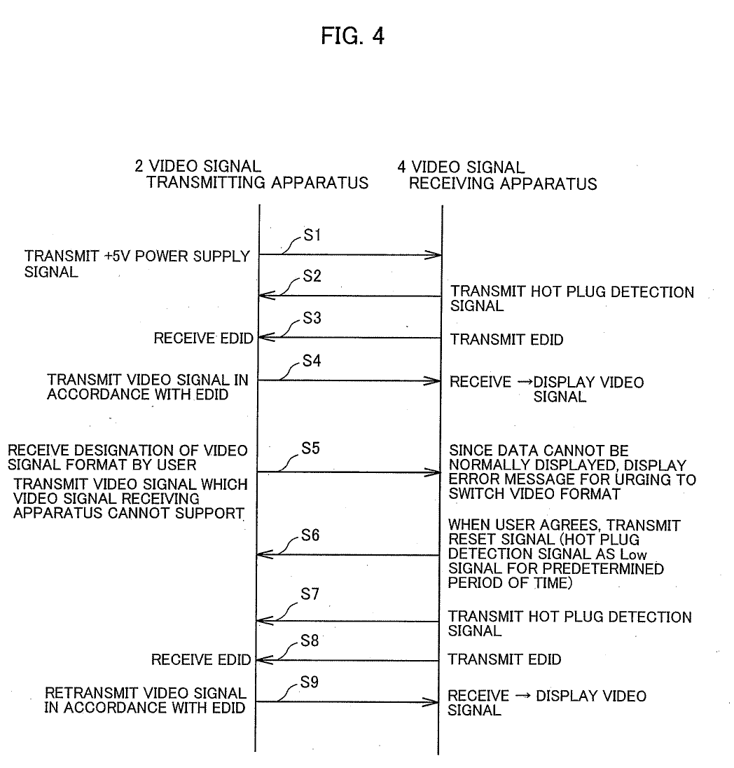

An operation of the embodiment of the present invention will be described below with reference to FIGS. 1 to 3 according to the timing chart in FIG. 4.

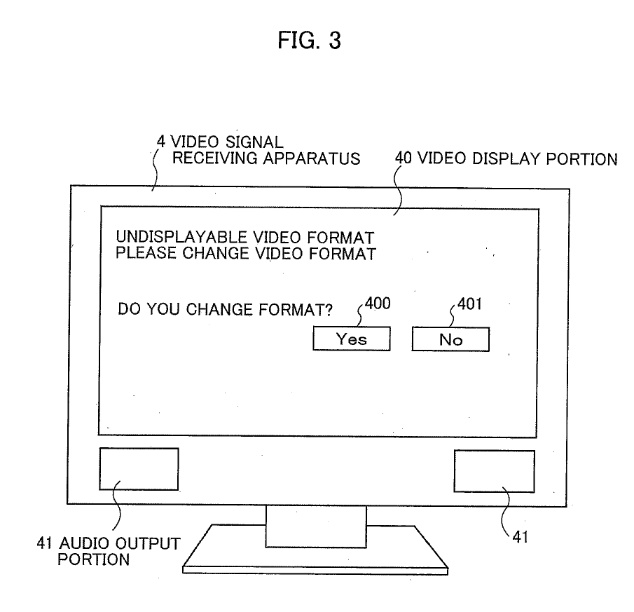

FIG. 3 is an exemplary schematic diagram showing an error message displayed on a video display portion according to the embodiment of the present invention. FIG. 3 shows a case in which the video signal transmitting apparatus 2 outputs a video signal to the video signal receiving apparatus 4 in a nonconforming video format.

A user connects the HDMI cables 3 to the HDMI ports of the respective apparatuses and turns on the power supplies of the video signal transmitting apparatus 2 and the video signal receiving apparatus 4.

FIG. 4 is an exemplary timing chart according to the embodiment of the present invention.

The +5V power supply signal output portion 26 of the video signal transmitting apparatus 2 transmits +5V power supply signal to the video signal receiving apparatus 4 (S1).

The control portion 43 of the video signal receiving apparatus 4 causes the +5V power supply signal receiving portion 46 to receive a +5V power supply signal, and preparation for receiving a video signal is completed. Thereafter, the control portion 43 transmits a hot plug detection signal (High signal) from the hot plug detection signal transmitting portion 47 to the video signal transmitting apparatus 2 (S2).

The control portion 23 of the video signal transmitting apparatus 2 receives the hot plug detection signal through the hot plug detection signal receiving portion 27 and then acquires the EDID 480 from the video signal receiving apparatus 4 (S3).

The user designates reproduction of the video data 220 stored in the storing portion 22 through the input portion 21.

The control portion 23 of the video signal transmitting apparatus 2 reads the conformable video data 220 from the storing portion 22 in accordance with a designation signal from the input portion 21, selects an appropriate video format in accordance with the EDID 480, and transmits the video data 220 as a video signal from the TMDS transmitting portion 25 (S4).

The control portion 43 of the video signal receiving apparatus 4 receives a video signal from the TMDS receiving portion 45, processes the video signal, controls the video display portion 40 to display video, and controls the audio output portion 41 to output audio.

For example, when the video signal receiving apparatus 4 supports EDID 480, 1080 progressive, and 1080 interlace as video formats, if the user selects a video format of 720 interlace to which the video signal receiving apparatus 4 does not conform, the video signal transmitting apparatus 2 transmits a video signal in the selected video format (S5).

At this time, since the control portion 43 of the video signal receiving apparatus 4 receives a video signal in a nonconforming format, the control portion 43 controls an error message to urge to switch video formats shown in FIG. 3 and controls the video display portion 40 to display the error message.

The user checks the error message displayed on the video display portion 40 to select Yes 400 or No 401 through the input portion 42. When the user selects No 401, the video signal receiving apparatus 4 must display a video signal in a video format in which the data cannot be displayed. For this reason, the video signal receiving apparatus 4 displays an error message again or, for example, a message such as “cannot be displayed” on the video display portion 40. The message to be displayed on the video display portion 40 is not limited to these messages.

When the user selects Yes 400 through the input portion 42, the control portion 43 of the video signal receiving apparatus 4 transmits a Low signal serving as a reset signal as a hot plug detection signal from the hot plug detection signal transmitting-portion 47 for a predetermined period of time (S6). The period of time falls within, for example, 100 ms or more and a range of 400 to 500 ms.

The control portion 23 of the video signal transmitting apparatus 2 receives the Low signal through the hot plug detection signal receiving portion 27.

At this time, the control portion 23 receives the Low signal for the predetermined period of time to reset a video format or the like selected by the user.

The control portion 43 of the video signal receiving apparatus 4 transmits a hot plug detection signal (High signal) from the hot plug detection signal transmitting portion 47 to the video signal transmitting apparatus 2 after preparation for receiving a video signal is completed (S7).

The control portion 23 of the video signal transmitting apparatus 2 receives the hot plug detection signal through the hot plug detection signal receiving portion 27 and then acquires the EDID 480 from the video signal receiving apparatus 4 (S8) The control portion 23 of the video signal transmitting apparatus 2 receives the EDID 480 through the EDID receiving portion 28, retransmits a video signal in an optimum video format to which the video signal receiving apparatus 4 conforms in accordance with the EDID 480. The control portion 43 receives the video signal in the conformable video format through the TMDS receiving portion 45, processes the video signal and transmits the processed video signal to the video display portion 40 and the audio output portion 41. The video display portion 40 displays a corresponding video, and the audio output portion 41 reproduces a corresponding audio (S9).

### Effect of Embodiment

According to the embodiment described above, even though a video signal is transmitted in a nonconforming video format, the video signal receiving apparatus 4 transmits a Low signal as a hot plug detection signal to the video signal transmitting apparatus 2 for a predetermined period of time to reset the video signal transmitting apparatus 2, so that a video signal in an optimum video format is retransmitted from the video signal transmitting apparatus 2.

The present invention is not limited to the embodiment. Various changes and modifications of the invention can be effected without departing from the spirit and scope of the invention.

What is claimed is:

1. A data receiving apparatus comprising:
a transmitting/receiving portion which transmits or receives data;
an output portion which performs data outputting of an audio signal or an image signal in accordance with reception of the data; and
a control portion which, when the received data has a format different from a format in which the data can be output from the output portion, controls the transmitting/receiving portion to transmit a reset signal.

2. A data receiving apparatus according to claim 1, wherein
the output portion includes at least one of an image display portion and a audio output portion.

3. A data receiving apparatus according to claim 1, wherein
the transmitting/receiving portion includes a reset signal transmitting portion which transmits a Low signal conforming to the HDMI (High Definition Multimedia Interface) as the reset signal.

4. A data receiving apparatus according to claim 1, wherein the transmitting/receiving portion includes a reset signal transmitting portion which transmits a Low signal as the reset signal and an EDID transmitting portion which transmits EDID (Extended Display Identification Data) serving as data in a format in which the data can be output from the output portion.

5. A data receiving apparatus according to claim 1, wherein
the control portion outputs a message for checking a change in format to the output portion when the data has a format different from a format in which the data can be output from the output portion.

6. A data receiving apparatus comprising:
a transmitting/receiving portion which transmits or receives data conforming to the HDMI standard;
an output portion which performs data outputting of an audio signal or an image signal in accordance with reception of the data; and
a control portion which, when the received data has a format different from a format in which the data can be output from the output portion, controls the transmitting/receiving portion to transmit a Low signal as a reset signal.

7. A data receiving apparatus according to claim 6, wherein
the output portion includes at least one of an image display portion and a audio output portion.

8. A data receiving apparatus according to claim 6, wherein
the transmitting/receiving portion includes a reset signal transmitting portion which transmits the Low signal as the reset signal and an EDID transmitting portion which transmits EDID (Extended Display Identification Data) serving as data in which the data can be output from the output portion.

9. A data receiving apparatus according to claim 6, wherein
the control portion outputs a message for checking a change in format to the output portion when the data has a format different from a format in which the data can be output from the output portion.

10. A data receiving apparatus comprising:
a transmitting/receiving portion which transmits or receives data;
an output portion which performs data outputting of an audio signal or an image signal in accordance with reception of the data; and
a control portion which, when the received data has a format different from a format in which the data can be output from the output portion, controls the transmitting/receiving portion to transmit a reset signal which makes data in a format in which the data can be output from the output portion transmitted.

11. A data receiving apparatus according to claim 10, wherein
the output portion includes at least one of an image display portion and a audio output portion.

12. A data receiving apparatus according to claim 10, wherein
the transmitting/receiving portion includes a reset signal transmitting portion which transmits a Low signal conforming to the HDMI (High Definition Multimedia Interface) as the reset signal.

13. A data receiving apparatus according to claim 10, wherein
the transmitting/receiving portion includes a reset signal transmitting portion which transmits a Low signal as the reset signal and an EDID transmitting portion which transmits EDID (Extended Display Identification Data) serving as data in a format in which the data can be output from the output portion.

14. A data receiving apparatus according to claim 10, wherein
the control portion outputs a message for checking a change in format to the output portion when the data has a format different from a format in which the data can be output from the output portion.
